(19) United States
(12) Patent Application Publication
(10) Pub. No.: US 2024/0377614 A1
(43) Pub. Date: Nov. 14, 2024

(54) OPTICAL SYSTEM AND IMAGE PICKUP APPARATUS

(71) Applicant: CANON KABUSHIKI KAISHA, Tokyo (JP)

(72) Inventor: Takumi SUZUKI, Saitama (JP)

(21) Appl. No.: 18/619,281

(22) Filed: Mar. 28, 2024

(30) Foreign Application Priority Data
May 12, 2023 (JP) 2023-079491

(51) Int. Cl. G02B 9/12

(52) U.S. Cl. CPC G02B 9/12

(57) ABSTRACT

An optical system includes, in order from an object side to an image side, a first lens unit having positive refractive power, a second lens unit having negative refractive power, and a rear lens unit. The first lens unit includes, in order from the object side to the image side, a first partial lens unit, a second partial lens unit, and a third partial lens unit. A first air gap is formed between the first partial lens unit and the second partial lens unit. A second air gap is formed between the second partial lens unit and the third partial lens unit. The first air gap is maximum among air gaps on an optical axis in the first lens unit, and the second air gap is second maximum among the air gaps on the optical axis in the first lens unit. Predetermined inequalities are satisfied.

### BACKGROUND

### Technical Field

One of the aspects of the embodiments relates to an optical system suitable for image pickup apparatuses such as digital still cameras, video cameras, surveillance cameras, and on-board (in-vehicle) cameras.

### Description of Related Art

An optical system as a small telephoto lens is disclosed that includes, in order from an object side to an image side, a first lens unit having positive refractive power, a second lens unit that has negative refractive power and moves during focusing, and a third lens unit having positive refractive power. In addition, an optical system beneficial to moving image capturing and dust and liquid proofing is disclosed, which uses an inner focus method or a rear focus method that performs focusing by moving a lens unit on an image side on a first lens unit closest to the object. These optical systems effectively correct various aberrations such as spherical aberration and chromatic aberration. Further, some optical systems may have an image stabilizing function for reducing (correcting) image blur caused by camera shake such as manual shake. These optical systems are demanded to have a large aperture ratio and high optical performance.

The optical system disclosed in Japanese Patent No. 6961441 has a large aperture ratio but is large as a whole. It is difficult to reduce the size of the optical system while the aperture ratio is properly set.

The optical system disclosed in International Publication No. 2021/220612 is small but has a small aperture ratio. Increasing the aperture ratio causes spherical aberration and chromatic aberration to increase, and it becomes difficult to secure high optical performance.

### SUMMARY

An optical system according to one aspect of the disclosure includes, in order from an object side to an image side, a first lens unit having positive refractive power, a second lens unit having negative refractive power, and a rear lens unit. The first lens unit includes, in order from the object side to the image side, a first partial lens unit, a second partial lens unit, and a third partial lens unit. A first air gap is formed between the first partial lens unit and the second partial lens unit. A second air gap is formed between the second partial lens unit and the third partial lens unit. The first air gap is maximum among air gaps on an optical axis in the first lens unit, and the second air gap is second maximum among the air gaps on the optical axis in the first lens unit. The second lens unit moves during focusing. The following inequalities are satisfied:

$$\begin{matrix}1. \leq f 1 A / f 1 \leq 2. \\ - 0.6 \leq f 1 A / f 1 B < 0 \\ 0.5 \leq LD / f \leq 1.\end{matrix}$$

where f1 is a focal length of the first lens unit, f1A is a focal length of the first partial lens unit, f1B is a focal length of the second partial lens unit, LD is a distance on the optical axis from a lens surface closest to an object in the optical system to an image plane, and f is a focal length of the optical system. An image pickup apparatus having the above optical system also constitutes another aspect of the disclosure.

Further features of the disclosure will become apparent from the following description of embodiments with reference to the attached drawings.

### BRIEF DESCRIPTION OF THE DRAWINGS

FIG. 1 is a sectional view of an optical system according to Example 1.

FIG. 2 is an aberration diagram of the optical system according to Example 1.

FIG. 3 is a sectional view of an optical system according to Example 2.

FIG. 4 is an aberration diagram of the optical system according to Example 2.

FIG. 5 is a sectional view of an optical system according to Example 3.

FIG. 6 is an aberration diagram of the optical system according to Example 3.

FIG. 7 is a sectional view of an optical system according to Example 4.

FIG. 8 is an aberration diagram of the optical system according to Example 4.

FIG. 9 is a sectional view of an optical system according to Example 5.

FIG. 10 is an aberration diagram of the optical system according to Example 5.

FIG. 11 is a sectional view of an optical system according to Example 6.

FIG. 12 is an aberration diagram of the optical system according to Example 6.

FIG. 13 is a sectional view of an optical system according to Example 7.

FIG. 14 is an aberration diagram of the optical system according to Example 7.

FIG. 15 is a schematic diagram of an image pickup apparatus.

FIG. 16 illustrates a method of calculating an inequality for an aspherical shape.

### DESCRIPTION OF THE EMBODIMENTS

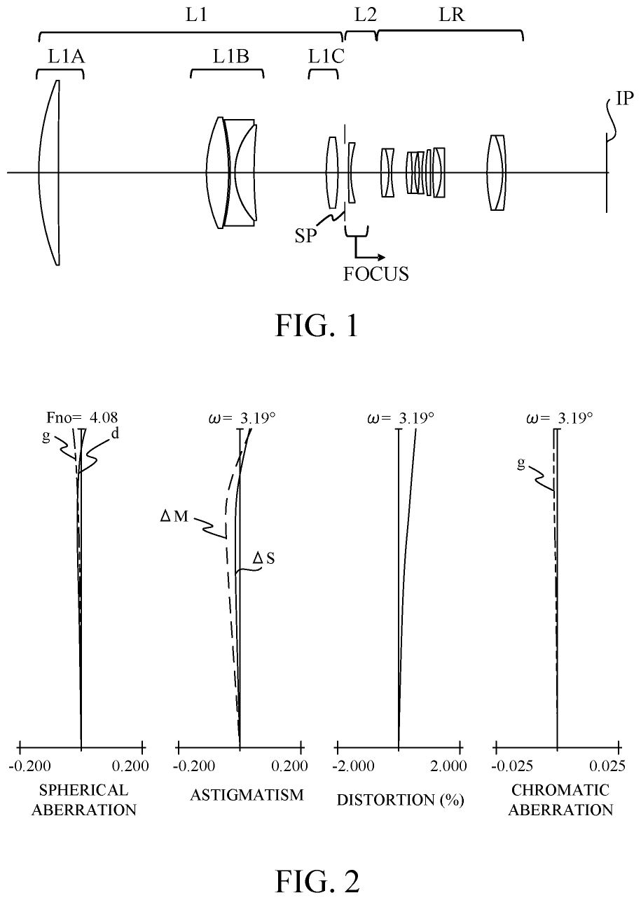

Examples of this disclosure will be described below with reference to the drawings. Prior to a specific description of Examples 1 to 7, common matters to each example will be described using FIG. 1 using an optical system according to Example 1.

The optical system according to each example is used as an imaging optical system in an image pickup apparatus such as a video camera, a digital still camera, a broadcasting camera, a surveillance camera, an on-board (in-vehicle) camera, and a film-based camera. However, the optical system according to each example can also be used as a projection optical system for an image projection apparatus (projector).

In the optical system according to each example, a lens unit is a group of one or more lenses that are stationary or move together during focusing or zooming, and a distance between adjacent lens units changes during focusing or zooming. The lens unit may include an aperture stop. The infinity side end and the close distance side end during focusing respectively indicate positions at both ends of a mechanically or controllably movable range on the optical axis of the lens unit that moves during focusing.

In FIG. 1, in the imaging optical system, a left side is an object side (front side), and a right side is an image side (rear side). Where i is the order of the lens units counted from the object side, Li represents an i-th lens unit. In the projection optical system, the object side will be referred to as the enlargement conjugate side, and the image side is referred to as the reduction conjugate side.

The optical system according to each example includes, in order from the object side to the image side, a first lens unit L1 having positive refractive power (refractive power is a reciprocal of a focal length), a second lens unit L2 having negative refractive power, and a rear lens unit LR. The first lens unit L1 includes, in order from the object side to the image side, a first partial lens unit L1A, a second partial lens unit L1B, and a third partial lens unit L1C. The first partial lens unit L1A and the second partial lens unit L1B are arranged with the maximum air gap (air distance or interval) on the optical axis in the first lens unit L1, and the second partial lens unit L1B and the third partial lens unit L1C are arranged with the second maximum air gap on the optical axis in the first lens unit L1. The optical system according to each example is a single focus lens.

During focusing from infinity to a close distance, the second lens unit L2 moves from the object side to the image side. An arrow labeled “Focus” indicates a moving direction of the second lens unit during focusing from infinity to a close distance.

SP represents an aperture stop that determines (limits) the light beam of the maximum aperture (Fno). IP represents an image plane. A photosensitive surface corresponding to an imaging surface of a solid-state image sensor (photoelectric conversion element) such as a CCD sensor or CMOS sensor or a film surface of a silver film is disposed on the image plane IP.

The optical system according to each example having the above configuration satisfies the following inequalities:

$$1. \leq f 1 A / f 1 \leq 2. \qquad ( 1 )$$

$$- 0.6 \leq f 1 A / f 1 B < 0 \qquad ( 2 )$$

where f1 is a focal length of the first lens unit L1, f1A is a focal length of the first partial lens unit L1A, and f1B is a focal length of the second partial lens unit L1B.

The optical system according to each example includes, in order from the object side, lens units having positive, negative, and positive refractive powers so as to reduce the overall optical length (hereinafter referred to as the overall lens length) and to properly correct various aberrations. The first lens unit L1 effectively corrects spherical aberration, coma, and chromatic aberration (lateral chromatic aberration, etc.). In addition, since a lens closer to the object side has a larger diameter in order to reduce the weight of the optical system, the number of lenses in the first partial lens unit L1A is reduced. A large number of lenses are provided to the second partial lens unit L1B and the third partial lens unit L1C so as to correct spherical aberration and chromatic aberration and reduce the weight. Further, disposing an aspherical lens made of a glass material with a high Abbe number and a high partial dispersion ratio in the third partial lens unit L1C can provide a strong correcting effect of spherical aberration and chromatic aberration. Thereby, the number of lenses included in the first lens unit L1 is further reduced, and the lightweight and compact configuration is further promoted.

Moreover, using the second lens unit L2 having negative refractive power as a focusing unit can reduce the weight of the focusing unit. In particular, effectively suppressing spherical aberration and longitudinal chromatic aberration in the first lens unit L1 enables the focusing unit to include a single lens, and to further reduce weight.

Inequality (1) defines a proper range of the ratio of the focal length f1A of the first partial lens unit L1A in the first lens unit L1 to the focal length f1 of the first lens unit L1, for achieving miniaturization and high optical performance. In a case where f1A/f1 becomes higher than the upper limit of inequality (1), spherical aberration, etc. can be suppressed, but the refractive power of the first partial lens unit L1A becomes too weak and it becomes difficult to reduce the size of the entire optical system. In a case where f1A/f1 becomes lower than the lower limit of inequality (1), the refractive power of the first partial lens unit L1A becomes too strong, and miniaturization is promoted but it becomes difficult to suppress spherical aberrations, etc.

Inequality (2) defines a proper range of the ratio of the focal length f1A of the first partial lens unit L1A in the first lens unit L1 to the focal length f1B of the second partial lens unit L1B, for achieving miniaturization and high optical performance. In a case where f1A/f1B becomes higher than the upper limit of inequality (2), spherical aberrations, etc. can be suppressed but the telephoto effect of the first partial lens unit L1A and the second partial lens unit L1B weakens and it becomes difficult to make small the entire optical system. In a case where f1A/f1B becomes lower than the lower limit of inequality (2), the telephoto effect of the first partial lens unit L1A and the second partial lens unit L1B becomes stronger and the miniaturization can be promoted but it becomes difficult to suppress spherical aberrations, etc.

Inequalities (1) and (2) may be replaced with the following inequalities (1a) and (2a):

$$1.1 \leq f 1 A / f 1 \leq 1.95 \qquad ( 1 a )$$

$$- 0.56 \leq f 1 A / f 1 B \leq - 0.05 \qquad ( 2 a )$$

Inequalities (1) and (2) may be replaced with the following inequalities (1b) and (2b):

$$1.15 \leq f 1 A / f 1 \leq 1.9 \qquad ( 1 b )$$

$$- 0.52 \leq f 1 A / f 1 B \leq - 0.1 \qquad ( 2 b )$$

Satisfying inequalities (1a) and (1b) can provide the effect of suppressing spherical aberration, coma, and longitudinal chromatic aberration. Satisfying inequalities (2a) and (2b) can more effectively provide the effect of reducing the overall lens length and suppressing chromatic aberration.

As described above, properly setting the arrangement and configuration of each lens unit and simultaneously satisfying inequalities (1) and (2) can provide a small and lightweight optical system that can maintain a sufficient aperture ratio while satisfactorily correcting various aberrations such as spherical aberration and chromatic aberration.

The optical system according to each example may satisfy at least one of the following inequalities (3) to (13) in addition to inequalities (1) and (2). Assume that f is a focal length of the optical system, and f2 is a focal length of the second lens unit L2. D1AB is an air gap on the optical axis between the first partial lens unit L1A and the second partial lens unit L1B in the first lens unit L1, and D1BC is an air gap on the optical axis between the second partial lens unit L1B and the third partial lens unit L1C.

LD is an overall lens length as the overall length of the optical system. The overall lens length is a distance on the optical axis from the lens surface (frontmost surface) closest to the object in the optical system to the image plane IP. D1Air is a sum of the air gap D1AB and the air gap D1BC in the first lens unit L1, and D1 is a thickness of the first lens unit L1 on the optical axis.

nd1CP is a refractive index for the d-line of a lens having positive refractive power disposed closest to the object in the third partial lens unit L1C, and vd1CP is an Abbe number of that lens based on the d-line. The Abbe number vd based on the d-line is expressed as vd=(Nd−1)/(NF−NC).

DRMAX is a maximum absolute value of an aspherical amount of an aspherical lens included in the first lens unit L1. Among the lenses included in the first lens unit L1, GP is a lens with the strongest positive refractive power, and SF1AP is a shape factor of the lens GP. GPR1 is a radius of curvature on the object side of the lens GP, and GPR2 is a radius of curvature on the image side of the lens GP. The aspherical amount and shape factor will be described below.

sk is a back focus of the optical system in an in-focus at infinity. The back focus is the distance on the optical axis from the most image-side lens surface (final surface) of the optical system to the image plane IP. In a case where a glass block with no or extremely weak refractive power (such as an optical filter or prism) is placed between the optical system and the image plane IP, calculate the back focus by converting the length of the glass block into air.

$$0.3 \leq f 1 A / f \leq 0.75 \qquad ( 3 )$$

$$1.3 \leq D 1 AB / D 1 BC \leq 7. \qquad ( 4 )$$

$$- 0.95 \leq f 2 / f 1 \leq - 0.4 \qquad ( 5 )$$

$$0.5 \leq LD / f \leq 1.2 \qquad ( 6 )$$

$$0.2 \leq f 1 / f \leq 0.5 \qquad ( 7 )$$

$$0.3 \leq D 1 Air / D 1 < 1. \qquad ( 8 )$$

$$1.3 \leq Nd 1 CP \leq 1.65 \qquad ( 9 )$$

$$65. \leq vd 1 CP \leq 100. \qquad ( 10 )$$

$$0. < DR MAX \leq 0.08 \qquad ( 11 )$$

$$- 2. \leq ( R 2 + R 1 ) / ( R 2 - R 1 ) \leq - 0.08 \qquad ( 12 )$$

$$0.05 \leq sk / LD \leq 0.24 \qquad ( 13 )$$

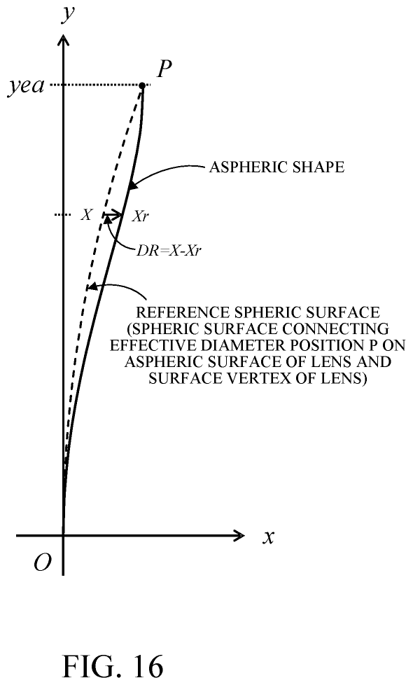

Referring now to FIG. 16, a description will be given of an aspherical amount. The aspherical amount DR is a difference in the optical axis direction between an arbitrary position X on a reference spherical surface as a spherical surface connecting an effective diameter position P on an aspherical surface of a lens and a surface vertex of the lens in the optical axis direction between that position and a position Xr on the aspheric surface at the same height as the position X. The aspheric amount is expressed as DR=X−Xr, as illustrated in FIG. 16. In each example, DRMAX is a maximum absolute value of the aspherical amount of the aspherical lens.

The shape factor SF1AP of the lens GP, which has the strongest positive refractive power among lenses included in the first lens unit L1 is expressed as follows:

$$SF 1 AP = ( R 2 + R 1 ) / ( R 2 - R 1 )$$

where R1 a radius of curvature of a lens surface on the object side of the lens GP, and R2 is a radius of curvature of a lens surface on the image side of the lens GP.

In a case where the lens surface is aspheric, the radius of curvature uses a radius of curvature of a base radius (radius of the reference quadratic surface) of the lens surface.

Inequality (3) defines a proper range of the ratio of the focal length f1A of the first partial lens unit L1A in the first lens unit L1 to the focal length f of the entire optical system, for achieving miniaturization and high optical performance. In a case where f1A/f becomes higher than the upper limit of inequality (3), spherical aberration can be suppressed, but the refractive power of the first partial lens unit L1A becomes too weak and it becomes difficult to miniaturize the entire optical system. In a case where f1A/f becomes lower than the lower limit of inequality (3), the refractive power of the first partial lens unit L1A becomes too strong, and miniaturization becomes easy but it becomes difficult to suppress spherical aberrations, etc.

Inequality (4) defines a proper range between the air gap D1AB between the first partial lens unit L1A and the second partial lens unit L1B in the first lens unit L1, and the air gap D1BC between the second partial lens unit L1B and the third partial lens unit L1C, for achieving miniaturization and high optical performance. In a case where D1AB/D1BC becomes higher than the upper limit of inequality (4), the second partial lens unit L1B is disposed on the image side, and the lens can be smaller but the height of a ray incident on the second partial lens unit L1B becomes lower, and it becomes difficult to suppress spherical aberrations, etc. In a case where D1AB/D1BC becomes lower than the lower limit of inequality (4), the second partial lens unit L1B is disposed on the object side, and the height of a ray incident on the second partial lens unit L1B becomes higher. As a result, spherical aberration can be suppressed but it becomes difficult to miniaturize the optical system.

Inequality (5) defines a proper range of a ratio between the focal lengths f1 and f2 of the first lens unit L1 and the second lens unit L2, for achieving miniaturization and high optical performance. In a case where f2/f1 becomes higher than the upper limit of inequality (5), the telephoto effect becomes stronger and the optical system can be smaller, but it becomes difficult to suppress chromatic aberrations, etc. In a case where f2/f1 becomes lower than the lower limit of inequality (5), the telephoto effect weakens and chromatic aberration can be suppressed but it becomes difficult to miniaturize the optical system.

Inequality (6) defines a proper range of a ratio between the overall lens length LD and the focal length f of the entire optical system, for achieving miniaturization and high optical performance. In a case where LD/f becomes higher than the upper limit of inequality (6), the overall lens length increases, which is effective in suppressing various aberrations such as spherical aberration, but it becomes difficult to miniaturize the optical system. In a case where LD/f becomes lower than the lower limit of inequality (6), the overall lens length and the size of the optical system reduce, but it becomes difficult to suppress various aberrations such as spherical aberration.

Inequality (7) defines a proper range of a ratio of the focal length f1 of the first lens unit L1 to the focal length f of the entire optical system, for achieving miniaturization and high optical performance. In a case where f1/f becomes higher than the upper limit of inequality (7), spherical aberrations, etc. can be suppressed but the refractive power of the first lens unit L1 becomes weaker and it becomes difficult to miniaturize the optical system. In a case where f1/f becomes lower than the lower limit of inequality (7), the refractive power of the first lens unit L1 becomes stronger, and the optical system can become small but it becomes difficult to suppress spherical aberrations, etc.

Inequality (8) defines a proper range of a ratio of a sum D1Air of the air gaps (D1AB+D1BC) in the first lens unit L1 and a thickness D1 of the first lens unit L1, for achieving weight reduction and high optical performance. In a case where D1Air/D1 becomes higher than the upper limit of inequality (8), weight reduction can be expected by reducing the number of lenses, but it becomes difficult to suppress various aberrations such as spherical aberration and chromatic aberration. In a case where D1Air/D1 becomes lower than the lower limit of inequality (8), the number of lenses increases, and various aberrations such as spherical aberration and chromatic aberration can be suppressed, but weight reduction becomes difficult.

Inequality (9) defines a proper range of the refractive index nd1CP of the positive lens closest to the object in the third partial lens unit L1C in the first lens unit L1, for achieving miniaturization and suppressing spherical aberration and coma. In a case where the refractive index nd1CP of the positive lens material becomes higher than the upper limit of inequality (9), it is beneficial to correcting various aberrations, but the Abbe number becomes insufficient and it becomes difficult to correct longitudinal chromatic aberration and lateral chromatic aberration, especially correction of secondary spectrum. As a result, in order to secure the desired optical performance, the overall system becomes larger and the number of lenses increases. In a case where the refractive index of the positive lens material becomes lower than the lower limit of inequality (9), it is beneficial to correcting longitudinal chromatic aberration and it becomes difficult to correct curvature of field and distortion.

Inequality (10) defines a proper range of the Abbe number vd1CP of the positive lens closest to the object in the third partial lens unit L1C in the first lens unit L1, for achieving miniaturization and suppressing spherical aberration and coma. In a case where vd1CP becomes higher than the upper limit of inequality (10), it is beneficial to correcting longitudinal chromatic aberration but it becomes difficult to secure the refractive power necessary for the glass material. In a case where vd1CP becomes lower than the lower limit of inequality (10), it becomes difficult to achieve first-order achromatization of longitudinal chromatic aberration and lateral chromatic aberration.

Inequality (11) defines a proper range of the maximum value DRMAX of the aspherical amount (absolute value) of the aspherical lens included in the rear lens unit LR. In a case where DRMAX becomes higher than the upper limit of inequality (11), the aspheric amount becomes too large and it becomes difficult to manufacture the aspheric lens. In a case DRMAX becomes lower than the lower limit of inequality (11), the aspherical amount becomes too small and it becomes difficult to correct spherical aberration and coma.

Inequality (12) defines a shape factor that maximizes the refractive index of the lens with the strongest positive refractive power among the one or more lenses included in the first partial lens unit LIA in the first lens unit L1, for satisfactorily correcting spherical aberration and coma in a wide-angle range. In a case where the shape factor becomes higher than the upper limit of inequality (12), it becomes difficult to satisfactorily correct spherical aberration, and the coma that occurs when the lens is decentered becomes larger. In a case where the shape factor becomes lower than the lower limit of inequality (12), spherical aberration and longitudinal chromatic aberration become larger.

Inequality (13) defines a proper range of a ratio of back focus sk to the overall lens length LD in an in-focus state at infinity. In a case where sk/LD becomes higher than the upper limit of inequality (13), the back focus relative to the overall lens length becomes too long and it becomes difficult to secure a space for properly placing the lenses to suppress various aberrations. In a case where sk/LD becomes lower than the lower limit of inequality (13), the back focus relative to the overall lens length becomes too short, and it becomes difficult to dispose the mechanical members for attaching the optical system (interchangeable lens, etc.) to the image pickup apparatus.

Inequalities (3) to (13) may be replaced with the following inequalities (3a) to (13a):

$$0.35 \leq f 1 A / f \leq 0.7 \qquad ( 3 a )$$

$$1.1 \leq D 1 AB / D 1 BC \leq 6.5 \qquad ( 4 a )$$

$$- 0.9 \leq f 2 / f 1 \leq - 0.45 \qquad ( 5 a )$$

$$0.55 \leq LD / f \leq 1. \qquad ( 6 a )$$

$$0.25 \leq f 1 / f \leq 0.45 \qquad ( 7 a )$$

$$0.65 \leq D 1 Air / D 1 \leq 0.97 \qquad ( 8 a )$$

$$1.32 \leq Nd 1 CP \leq 1.6 \qquad ( 9 a )$$

$$70. \leq vd 1 CP \leq 97. \qquad ( 10 a )$$

$$0.01 \leq DR MAX \leq 0.07 \qquad ( 11 a )$$

$$- 1.9 \leq ( R 2 + R 1 ) / ( R 2 - R 1 ) \leq - 0.9 \qquad ( 12 a )$$

$$0.6 \leq sk / LD \leq 0.22 \qquad ( 13 a )$$

Inequalities (3) to (13) may be replaced with the following inequalities (3b) to (13b):

$$0.385 \leq f 1 A / f \leq 0.68 \qquad ( 3 b )$$

$$1.25 \leq D 1 AB / D 1 BC \leq 6. \qquad ( 4 b )$$

$$- 0.85 \leq f 2 / f 1 \leq - 0.5 \qquad ( 5 b )$$

$$0.625 \leq LD / f \leq 0.85 \qquad ( 6 b )$$

$$0.3 \leq f 1 / f \leq 0.42 \qquad ( 7 b )$$

$$0.7 \leq D 1 Air / D 1 \leq 0.93 \qquad ( 8 b )$$

$$1.4 \leq Nd 1 CP \leq 1.55 \qquad ( 9 b )$$

$$72. \leq vd 1 CP \leq 95. \qquad ( 10 b )$$

$$0.02 \leq DR MAX \leq 0.062 \qquad ( 11 b )$$

$$- 1.8 \leq ( R 2 + R 1 ) / ( R 2 - R 1 ) \leq - 0.1 \qquad ( 12 b )$$

$$0.08 \leq sk / LD \leq 0.2 \qquad ( 13 b )$$

The optical system according to each example may satisfy at least one of the following conditions.

In the first lens unit LI, the first partial lens unit L1A may have positive refractive power, the second partial lens unit L1B may have negative refractive power, and the third partial lens unit L1C may have positive refractive power. This configuration provides a positive and negative lens unit arrangement from the object side, a so-called telephoto arrangement, and the size of the entire optical system and chromatic aberration can be reduced. In addition, disposing the third partial lens unit L1C having positive refractive power can properly set the positive refractive power of first partial lens unit L1A.

The second partial lens unit L1B may consist of one negative lens and two positive lenses. Thereby, longitudinal chromatic aberration, spherical aberration, and coma can be properly suppressed. The second partial lens unit L1B with three lens units can increase the selection freedom of the glass material in the achromatization for the second partial lens unit L1B, and facilitate the corrections of various aberrations and achromatization within the lens unit.

The third partial lens unit L1C may include an aspherical lens. The aspherical surface lens disposed in the first lens unit L1 can satisfactorily correct spherical aberration and coma and reduce the weight of the optical system by reducing the number of lenses in the first lens unit L1. In addition, the aspherical lens disposed in the third partial lens unit L1C can reduce the size of the aspherical lens, and manufacturing becomes easier. Furthermore, the aspherical lens may be disposed closest to the object in the third partial lens unit L1C.

The second lens unit L2 as a focusing unit may consist of a single negative lens. This configuration can reduce the weight of the focusing unit and increase the moving speed of the focusing unit during focusing.

The lens closest to the image plane in the rear lens unit may be a lens having a convex surface on the image side (a surface that is convex toward the image side). This configuration can relatively easily to secure the back focus, and suppress the collection of unnecessary light (ghost) caused by the image sensor.

Additionally, in each example, a protective glass may be placed closer to the object than the first lens unit L1 so as to protect the lens closest to the object of the optical system. Furthermore, a protective glass or a low-pass filter may be placed between the lens closest to the image plane of the optical system and the image plane IP. A member that has no or extremely weak refractive power, such as a protective glass or a low-pass filter, disposed closest to the object or the image plane is not treated as a lens that constitutes the optical system. The member having the “extremely weak refractive power” is, for example, a member in which an absolute value of a focal length of the member is five times as large as the focal length of the entire optical system or more.

The aperture stop SP may be disposed closest to the object in the second lens unit L2. Thereby, it becomes easier to reduce the diameter of the aperture stop SP and secure a light amount at a peripheral angle of view.

The lens adjacent to the aperture stop SP on the image side may be a cemented lens of a positive lens and a negative lens. Thereby, it becomes easier to correct curvature of field and lateral chromatic aberration.

The whole or part of any lens unit in the optical system may be moved as an image stabilizing unit in a direction that includes a component orthogonal to the optical axis to reduce image blur caused by shake such as manual shake. This movement includes rotation about a point on the optical axis. In this case, in particular, a part of the rear lens unit LR may be set to the image stabilizing unit. The number of lenses and the shape of the image stabilizing lens is not particularly limited but the image stabilizing unit may have negative refractive power. The image stabilizing unit may have at least two negative lenses.

The optical system may not include a diffractive optical element (DOE). The DOE in the optical system is beneficial to correcting chromatic aberration, but diffraction flare occurs in the DOE.

A specific description will now be given of Examples 1 to 7. In the following description, the lens unit and the arrangement of the lenses are arranged in order from the object side to the image side.

### EXAMPLE 1

The optical system according to Example 1 illustrated in FIG. 1 consists of a first lens unit L1 having positive refractive power, a second lens unit L2 having negative refractive power, and a rear lens unit LR having positive refractive power.

The first lens unit L1 consists of a first partial lens unit L1A having positive refractive power, a second partial lens unit L1B having negative refractive power, and a third partial lens unit L1C having positive refractive power. The second partial lens unit L1B consists of one positive lens and a cemented lens in which a negative lens and a positive lens are cemented. The third partial lens unit L1C consists of a single positive lens with aspherical surfaces on both sides.

The second lens unit L2 consists of an aperture stop SP disposed closest to the object and a single negative lens disposed on the image side of the aperture stop SP.

In the rear lens unit LR, a lens closest to the image plane is a cemented lens in which a positive lens and a negative lens are cemented, and the lens surface closest to the image plane is convex.

After Example 7, numerical example 1 corresponding to Example 1 is illustrated. In numerical example 1, a surface number i represents the order of the surfaces counted from the object side. r represents a radius of curvature (mm) of an i-th surface from the object side. d represents a lens thickness or air gap (mm) between i-th and (i+1)-th surfaces, and nd represents a refractive index for the d-line of the optical material between the i-th and (i+1)-th surfaces. vdi represents an Abbe number based on the d-line of the optical material between the i-th and (i+1)-th surfaces.

A half angle of view (°) is calculated by paraxial calculation. BF represents a back focus (mm) and corresponds to sk in inequality (13). An overall lens length corresponds to LD in inequality (13).

An asterisk “*” attached to a surface number means that that surface has an aspherical shape. The aspherical shape is defined as follows:

$$X = \frac{\frac{{H}^{2}}{R}}{1 + \sqrt{1 - ( 1 + K ) {( \frac{H}{R} )}^{2}}} + A 4 {H}^{4} + A 6 {H}^{6} A 8 {H}^{8}$$

where X is a displacement amount from a surface vertex in the optical axis direction, and H is a height from the optical axis in the direction orthogonal to the optical axis direction. A light traveling direction is set positive. R is a paraxial radius of curvature. K is a conic constant. A4, A6, and A8 are aspheric coefficients, respectively. A conic constant and aspheric coefficient “e±x” means×10^{±x}.

Table 1 summarizes values corresponding to inequalities (1) to (13) in numerical example 1. (R2+R1)/(R2−R1) in inequality (12) is written as SF1AP in Table 1. Numerical example 1 satisfies all inequalities (1) to (13).

FIG. 2 illustrates a longitudinal aberration (spherical aberration, astigmatism, distortion, and chromatic aberration) of the optical system according to numerical example 1 in an in-focus state at infinity. In the spherical aberration diagram, Fno represents an F-number. A solid line illustrates a spherical aberration amount for the d-line (wavelength 587.6 nm), and an alternate long and two short dashes line illustrates a spherical aberration amount for the g-line (wavelength 435.8 nm). In the astigmatism diagram, a solid line S illustrates an astigmatism amount on the sagittal image plane. A broken line M illustrates an astigmatism amount on the meridional image plane. The distortion diagram illustrates a distortion amount for the d-line. The chromatic aberration diagram illustrates a lateral chromatic aberration amount for the g-line. ω is a half angle of view (°).

A description regarding the numerical examples and longitudinal aberration diagram is also applied to other numerical examples described below.

### EXAMPLE 2

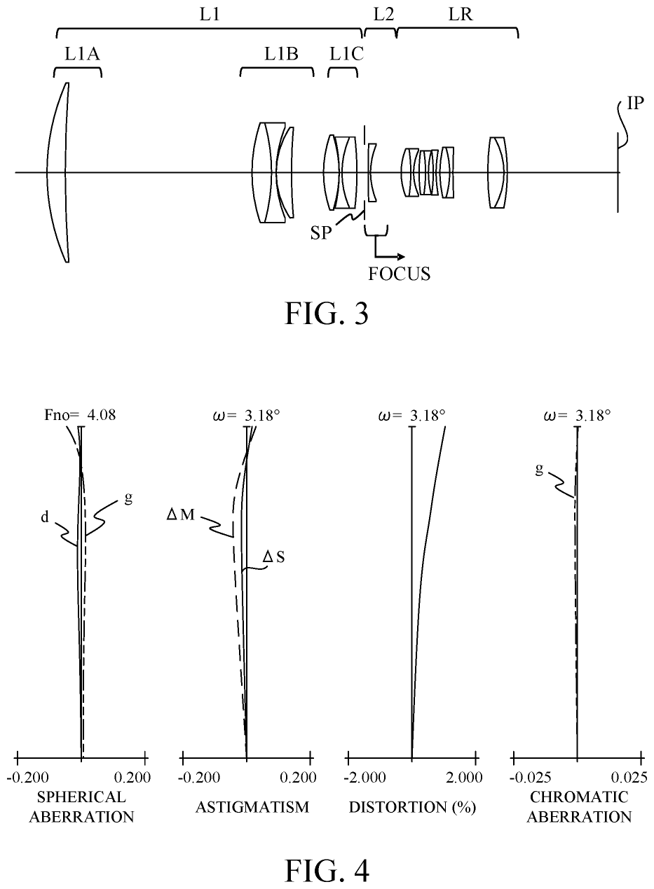

The optical system according to Example 2 illustrated in FIG. 3 consists of a first lens unit L1 having positive refractive power, a second lens unit L2 having negative refractive power, and a rear lens unit LR having positive refractive power.

The first lens unit L1 consists of a first partial lens unit L1A having positive refractive power, a second partial lens unit L1B having negative refractive power, and a third partial lens unit L1C having positive refractive power. The second partial lens unit L1B consists of a cemented lens in which a positive lens and a negative lens are cemented together, and one positive lens. The third partial lens unit L1C consists of a single positive lens with aspheric surfaces on both sides, and a cemented lens of a negative lens and a positive lens.

The second lens unit L2 consists of an aperture stop SP disposed closest to the object, and a single negative lens disposed on the image side of the aperture stop SP.

In the rear lens unit LR, a lens closest to the image plane is a cemented lens in which a positive lens and a negative lens are cemented, and a lens surface closest to the image plane is convex.

After Example 7, numerical example 2 corresponding to Example 2 is illustrated. Table 1 summarizes values corresponding to inequalities (1) to (13) in numerical example 2. Numerical example 2 satisfies all inequalities (1) to (13).

FIG. 4 illustrates a longitudinal aberration of the optical system according to numerical example 2 in an in-focus state at infinity.

### EXAMPLE 3

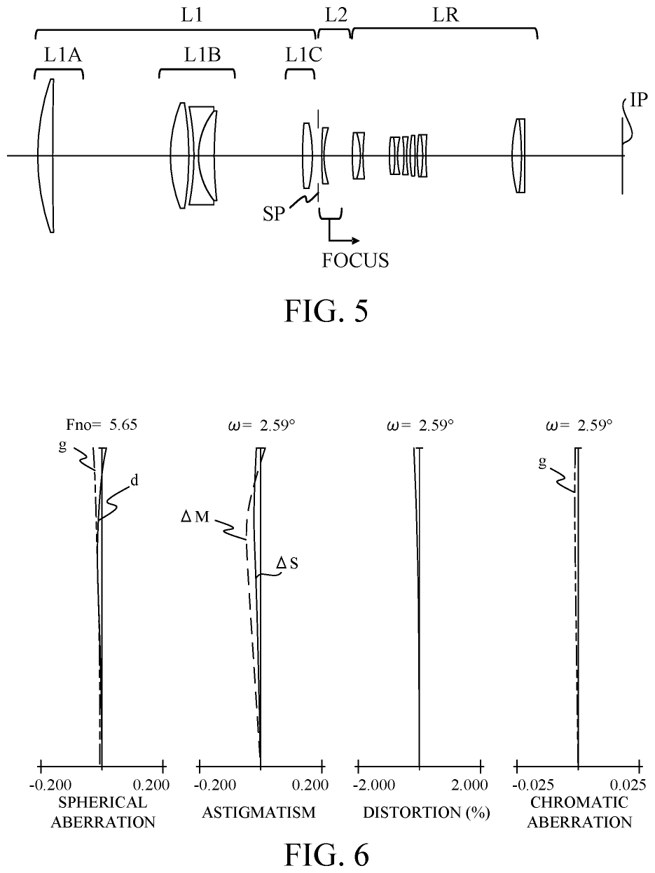

The optical system according to Example 3 illustrated in FIG. 5 consists of a first lens unit L1 having positive refractive power, a second lens unit L2 having negative refractive power, and a rear lens unit LR having negative refractive power.

The first lens unit L1 consists of a first partial lens unit L1A having positive refractive power, a second partial lens unit L1B having negative refractive power, and a third partial lens unit L1C having positive refractive power. The second partial lens unit L1B consists of one positive lens and a cemented lens in which a negative lens and a positive lens are cemented. The third partial lens unit L1C consists of a single positive lens with aspherical surfaces on both sides.

The second lens unit L2 consists of an aperture stop SP disposed closest to the object, and a single negative lens disposed on the image side on the aperture stop SP.

In the rear lens unit LR, a lens closest to the image plane is a cemented lens in which a positive lens and a negative lens are cemented, and a lens surface closest to the image plane is convex.

After Example 7, numerical example 3 corresponding to Example 3 is illustrated. Table 1 summarizes values corresponding to inequalities (1) to (13) in numerical example 3. Numerical example 3 satisfies all inequalities (1) to (13).

FIG. 6 illustrates a longitudinal aberration of the optical system according to numerical example 3 in an in-focus state at infinity.

### EXAMPLE 4

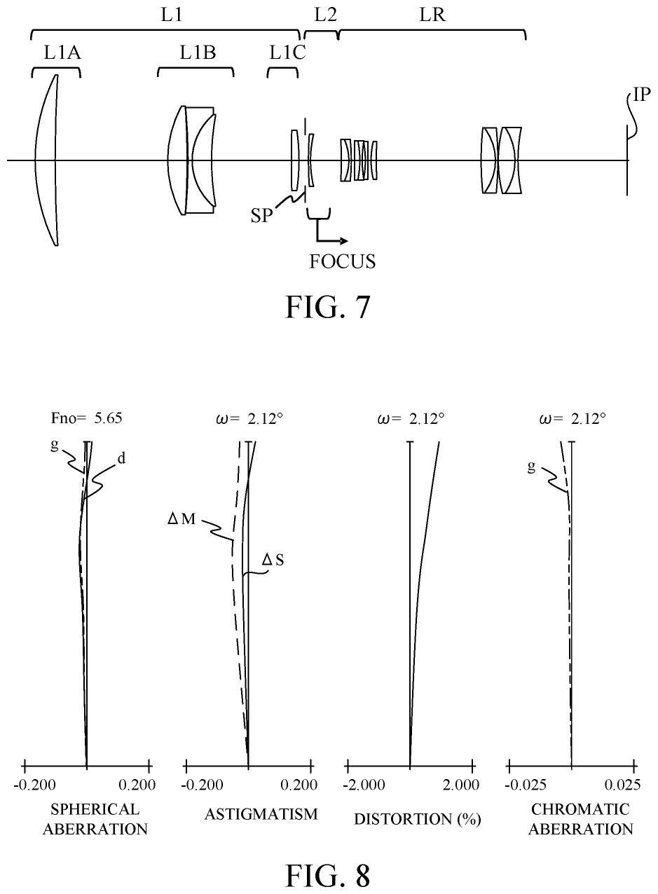

The optical system according to Example 4 illustrated in FIG. 7 consists of a first lens unit L1 having positive refractive power, a second lens unit L2 having negative refractive power, and a rear lens unit LR having negative refractive power.

The first lens unit L1 consists of a first partial lens unit L1A having positive refractive power, a second partial lens unit L1B having negative refractive power, and a third partial lens unit L1C having positive refractive power. The second partial lens unit L1B consists of one positive lens and a cemented lens in which a negative lens and a positive lens are cemented. The third partial lens unit L1C consists of a single positive lens with aspherical surfaces on both sides.

The second lens unit L2 consists of an aperture stop SP disposed closest to the object, and a single negative lens disposed on the image side of the aperture stop SP.

In the rear lens unit LR, a lens closest to the image plane is a cemented lens in which a positive lens and a negative lens are cemented, and a lens surface closest to the image plane is concave.

After Example 7, numerical example 4 corresponding to Example 4 is illustrated. Table 1 summarizes values corresponding to inequalities (1) to (13) in numerical example 4. Numerical example 4 satisfies all inequalities (1) to (13).

FIG. 8 illustrates a longitudinal aberration of the optical system according to numerical example 4 in an in-focus state at infinity.

### EXAMPLE 5

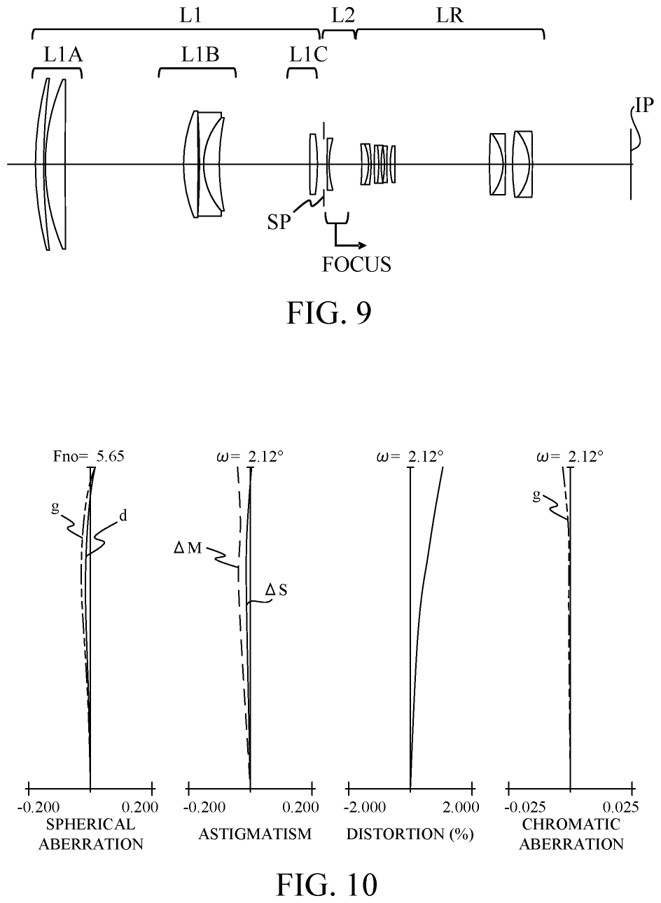

The optical system according to Example 5 illustrated in FIG. 9 consists of a first lens unit L1 having positive refractive power, a second lens unit L2 having negative refractive power, and a rear lens unit LR having negative refractive power.

The first lens unit L1 consists of a first partial lens unit L1A having positive refractive power, a second partial lens unit L1B having negative refractive power, and a third partial lens unit L1C having positive refractive power. The second partial lens unit L1B consists of one positive lens and a cemented lens in which a negative lens and a positive lens are cemented. The third partial lens unit L1C consists of a single positive lens with aspherical surfaces on both sides.

The second lens unit L2 consists of an aperture stop SP disposed closest to the object, and a single negative lens disposed on the image side of the aperture stop SP.

In the rear lens unit LR, a lens closest to the image plane is a cemented lens in which a positive lens and a negative lens are cemented, and a lens surface closest to the image plane is convex.

After Example 7, numerical example 5 corresponding to Example 5 is illustrated. Table 1 summarizes values corresponding to inequalities (1) to (13) in numerical example 5. Numerical example 5 satisfies all inequalities (1) to (13).

FIG. 10 illustrates a longitudinal aberration of the optical system according to numerical example 5 in an in-focus state at infinity.

### EXAMPLE 6

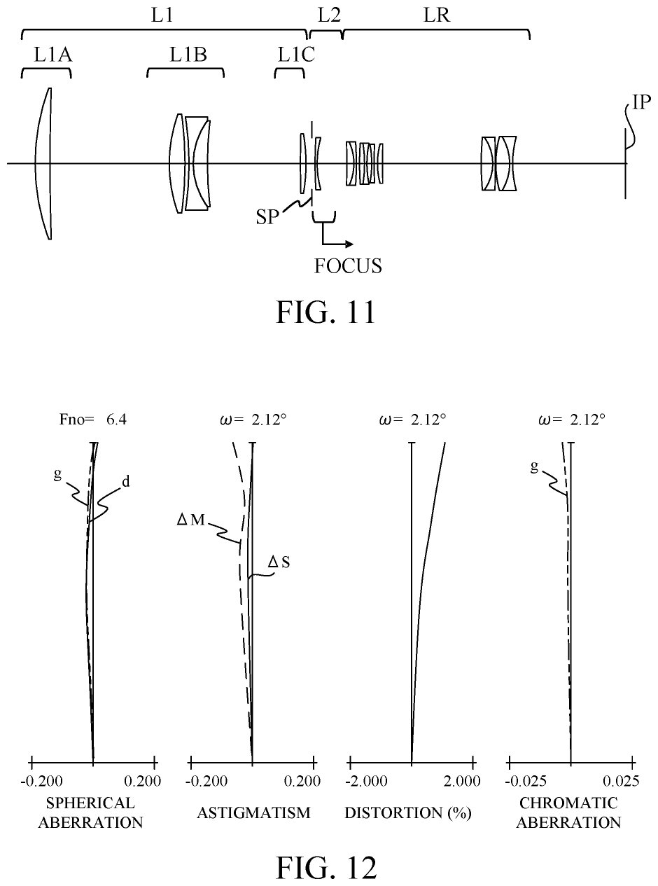

The optical system according to Example 6 illustrated in FIG. 11 consists of a first lens unit L1 having positive refractive power, a second lens unit L2 having negative refractive power, and a rear lens unit LR having negative refractive power.

The first lens unit L1 consists of a first partial lens unit L1A having positive refractive power, a second partial lens unit L1B having negative refractive power, and a third partial lens unit L1C having positive refractive power. The second partial lens unit L1B consists of one positive lens and a cemented lens in which a negative lens and a positive lens are cemented. The third partial lens unit L1C consists of a single positive lens with aspherical surfaces on both sides.

The second lens unit L2 consists of an aperture stop SP disposed closest to the object, and a single negative lens disposed on the image side of the aperture stop SP.

In the rear lens unit LR, a lens closest to the image plane is a cemented lens in which a positive lens and a negative lens are cemented, and a lens surface closest to the image plane is concave.

After Example 7, numerical example 6 corresponding to Example 6 is illustrated. Table 1 summarizes values corresponding to Equations (1) to (13) in numerical example 6. Numerical Example 6 satisfies all inequalities (1) to (13).

FIG. 12 illustrates a longitudinal aberration of the optical system according to numerical example 6 in an in-focus state at infinity.

### EXAMPLE 7

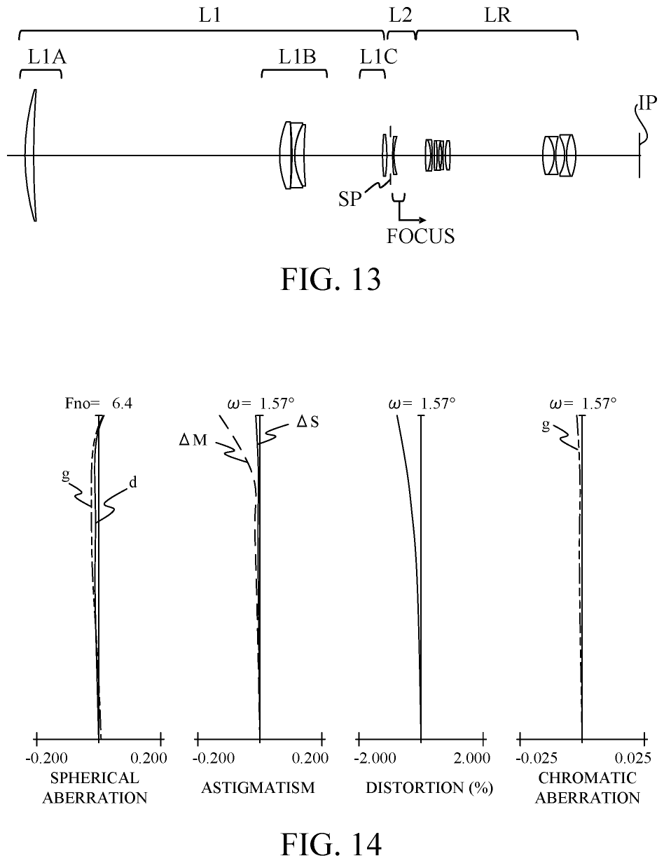

The optical system according to Example 7 illustrated in FIG. 13 consists of a first lens unit L1 having positive refractive power, a second lens unit L2 having negative refractive power, and a rear lens unit LR having negative refractive power.

The first lens unit L1 consists of a first partial lens unit L1A having positive refractive power, a second partial lens unit L1B having negative refractive power, and a third partial lens unit L1C having positive refractive power. The second partial lens unit L1B consists of one positive lens and a cemented lens in which a negative lens and a positive lens are cemented. The third partial lens unit L1C consists of a single positive lens with aspherical surfaces on both sides.

The second lens unit L2 consists of an aperture stop SP disposed closest to the object, and a single negative lens disposed on the image side of the aperture stop SP.

In the rear lens unit LR, a lens closest to the image plane is a cemented lens in which a negative lens and a positive lens are cemented, and a lens surface closest to the image plane is convex.

After this example, numerical example 7 corresponding to this example is illustrated. Table 1 summarizes values corresponding to inequalities (1) to (13) in numerical example 7. Numerical example 7 satisfies all inequalities (1) to (13).

FIG. 14 illustrates a longitudinal aberration of the optical system according to numerical example 7 in an in-focus state at infinity.

### NUMERICAL EXAMPLE 1

UNIT: mm
SURFACE DATA

| Surface No. | r | d | nd | νd |
|---|---|---|---|---|
| 1 | 138.407 | 10.73 | 1.59349 | 67.0 |
| 2 | 2654.662 | 80.97 | | |
| 3 | 75.053 | 12.27 | 1.43875 | 94.7 |
| 4 | −135.148 | 0.87 | | |
| 5 | −128.318 | 2.50 | 1.61340 | 44.3 |
| 6 | 38.286 | 0.05 | | |
| 7 | 38.229 | 10.39 | 1.43875 | 94.7 |
| 8 | 234.203 | 39.50 | | |
| 9* | 89.902 | 6.53 | 1.49700 | 81.5 |
| 10* | −141.385 | 3.73 | | |
| 11 (SP) | ∞ | (Variable) | | |
| 12 | 427.087 | 1.30 | 1.72916 | 54.7 |
| 13 | 58.076 | (Variable) | | |
| 14 | 123.001 | 4.28 | 1.80810 | 22.8 |
| 15 | −48.164 | 1.50 | 1.63930 | 44.9 |
| 16 | 62.467 | 8.12 | | |
| 17 | 73.025 | 3.19 | 1.72047 | 34.7 |
| 18 | −98.066 | 1.50 | 1.52841 | 76.5 |
| 19 | 41.109 | 2.35 | | |
| 20 | −92.421 | 1.50 | 1.72916 | 54.7 |
| 21 | 63.599 | 2.14 | | |
| 22 | 85.669 | 2.57 | 1.59551 | 39.2 |
| 23 | −1173.093 | 1.30 | | |
| 24 | 132.455 | 4.55 | 1.68893 | 31.1 |
| 25 | −34.098 | 1.80 | 1.92286 | 20.9 |
| 26 | 2362.365 | 23.25 | | |
| 27 | 87.936 | 8.56 | 1.73800 | 32.3 |
| 28 | −54.431 | 1.80 | 1.92286 | 20.9 |
| 29 | −161.546 | (Variable) | | |
| Image Plane | ∞ | | | |

ASPHERIC DATA
9th Surface
K = 0.00000e+00 A 4 = −1.38789e−06 A 6 = 4.93152e−10
A 8 = 1.04009e−12
10th Surface
K = 0.00000e+00 A 4 = −1.53131e−06 A 6 = 1.42620e−09
A 8 = 5.66619e−14
VARIOUS DATA

| | |
|---|---|
| Focal Length | 388.73 |
| Fno | 4.08 |
| Half Angle of View (°) | 3.19 |
| Image Height | 21.64 |
| Overall Lens Length | 310.74 |
| BF | 55.06 |
| d11 | 2.00 |
| d13 | 16.45 |
| d29 | 55.06 |

LENS UNIT DATA

| Lens Unit | Starting Surface | Focal Length |
|---|---|---|
| 1 | 1 | 145.31 |
| 2 | 12 | −92.32 |
| 3 | 14 | 993.19 |

### NUMERICAL EXAMPLE 2

UNIT: mm
SURFACE DATA

| Surface No. | r | d | nd | νd |
|---|---|---|---|---|
| 1 | 121.224 | 9.95 | 1.59349 | 67.0 |
| 2 | 617.686 | 101.59 | | |
| 3 | 84.722 | 10.64 | 1.43875 | 94.7 |
| 4 | −100.890 | 2.50 | 1.73800 | 32.3 |
| 5 | 65.208 | 0.02 | | |
| 6 | 44.339 | 8.29 | 1.43875 | 94.7 |
| 7 | 263.256 | 17.46 | | |
| 8* | 58.770 | 8.52 | 1.43875 | 94.7 |
| 9* | −61.943 | 0.02 | | |
| 10 | −82.556 | 1.50 | 1.88100 | 40.1 |
| 11 | 46.947 | 8.16 | 1.77830 | 23.9 |
| 12 | −165.105 | 4.11 | | |
| 13 (SP) | ∞ | (Variable) | | |
| 14 | 479.548 | 1.30 | 1.53775 | 74.7 |
| 15 | 38.920 | (Variable) | | |
| 16 | 34.650 | 5.31 | 1.58144 | 40.8 |
| 17 | −81.081 | 1.50 | 1.48749 | 70.2 |
| 18 | 29.016 | 2.92 | | |
| 19 | 82.260 | 3.61 | 1.72047 | 34.7 |
| 20 | −71.571 | 1.50 | 1.52841 | 76.5 |
| 21 | 44.399 | 2.69 | | |
| 22 | −77.374 | 1.50 | 1.72916 | 54.7 |
| 23 | 66.797 | 2.08 | | |
| 24 | 58.807 | 5.29 | 1.78880 | 28.4 |
| 25 | −47.521 | 1.80 | 1.92286 | 20.9 |
| 26 | 245.871 | 18.91 | | |
| 27 | 126.124 | 8.86 | 1.73800 | 32.3 |
| 28 | −37.407 | 1.80 | 1.92286 | 20.9 |
| 29 | −99.229 | (Variable) | | |
| Image Plane | ∞ | | | |

ASPHERIC DATA
8th Surface
K = 0.00000e+00 A 4 = −8.29406e−07 A 6 = −2.98580e−10
9th Surface
K = 0.00000e+00 A 4 = 1.08069e−06 A 6 = 3.34995e−10
VARIOUS DATA

| | |
|---|---|
| Focal Length | 389.12 |
| Fno | 4.08 |
| Half Angle of View (°) | 3.18 |
| Image Height | 21.64 |
| Overall Lens Length | 310.56 |
| BF | 60.09 |
| d13 | 2.00 |
| d15 | 16.62 |
| d29 | 60.09 |

LENS UNIT DATA

| Lens Unit | Starting Surface | Focal Length |
|---|---|---|
| 1 | 1 | 155.61 |
| 2 | 14 | −78.85 |
| 3 | 16 | 501.29 |

### NUMERICAL EXAMPLE 3

UNIT: mm
SURFACE DATA

| Surface No. | r | d | nd | νd |
|---|---|---|---|---|
| 1 | 132.665 | 8.52 | 1.59349 | 67.0 |
| 2 | 2107.440 | 66.58 | | |
| 3 | 81.063 | 10.57 | 1.43875 | 94.7 |
| 4 | −170.759 | 2.79 | | |
| 5 | −144.718 | 2.50 | 1.61340 | 44.3 |
| 6 | 41.583 | 0.05 | | |
| 7 | 41.532 | 8.86 | 1.43875 | 94.7 |
| 8 | 214.811 | 50.00 | | |
| 9* | 167.363 | 5.60 | 1.43875 | 94.7 |
| 10* | −92.989 | 3.26 | | |
| 11 (SP) | ∞ | (Variable) | | |
| 12 | 204.486 | 1.30 | 1.55200 | 70.7 |
| 13 | 51.773 | (Variable) | | |
| 14 | 120.972 | 4.58 | 1.80518 | 25.4 |
| 15 | −42.301 | 1.50 | 1.79952 | 42.2 |
| 16 | 105.985 | 14.90 | | |
| 17 | 77.053 | 3.16 | 1.72047 | 34.7 |
| 18 | −73.504 | 1.50 | 1.53775 | 74.7 |
| 19 | 44.508 | 3.63 | | |
| 20 | −77.141 | 1.50 | 1.72916 | 54.7 |
| 21 | 69.069 | 1.98 | | |
| 22 | 74.389 | 2.74 | 1.62004 | 36.3 |
| 23 | −285.860 | 1.30 | | |
| 24 | 81.067 | 3.09 | 1.65412 | 39.7 |
| 25 | −69.459 | 1.80 | 1.92286 | 20.9 |
| 26 | 138.431 | 48.76 | | |
| 27 | 82.964 | 5.36 | 1.67300 | 38.3 |
| 28 | −155.295 | 1.80 | 1.92286 | 20.9 |
| 29 | −2564.862 | (Variable) | | |
| Image Plane | ∞ | | | |

ASPHERIC DATA
9th Surface
K = 0.00000e+00 A 4 = −1.53309e−06 A 6 = −2.58260e−10
10th Surface
K = 0.00000e+00 A 4 = −1.34677e−06
VARIOUS DATA

| | |
|---|---|
| Focal Length | 479.13 |
| Fno | 5.65 |
| Half Angle of View (°) | 2.59 |
| Image Height | 21.64 |
| Overall Lens Length | 331.00 |
| BF | 55.35 |
| d11 | 2.00 |
| d13 | 16.02 |
| d29 | 55.35 |

LENS UNIT DATA

| Lens Unit | Starting Surface | Focal Length |
|---|---|---|
| 1 | 1 | 160.43 |
| 2 | 12 | −125.97 |
| 3 | 14 | −1443.93 |

### NUMERICAL EXAMPLE 4

UNIT: mm
SURFACE DATA

| Surface No. | r | d | nd | νd |
|---|---|---|---|---|
| 1 | 119.231 | 12.36 | 1.59349 | 67.0 |
| 2 | 859.310 | 69.59 | | |
| 3 | 70.151 | 12.13 | 1.43875 | 94.7 |
| 4 | −461.124 | 0.53 | | |
| 5 | −329.909 | 2.50 | 1.61340 | 44.3 |
| 6 | 37.506 | 0.05 | | |
| 7 | 37.459 | 11.98 | 1.43875 | 94.7 |
| 8 | 158.144 | 49.36 | | |
| 9* | 428.674 | 4.78 | 1.49700 | 81.5 |
| 10* | −143.738 | 3.79 | | |
| 11 (SP) | ∞ | (Variable) | | |
| 12 | 231.481 | 1.30 | 1.74100 | 52.6 |
| 13 | 69.656 | (Variable) | | |
| 14 | −232.122 | 4.64 | 1.80518 | 25.4 |
| 15 | −31.586 | 1.50 | 1.91082 | 35.2 |
| 16 | −124.083 | 2.00 | | |
| 17 | −1807.348 | 3.29 | 1.80810 | 22.8 |
| 18 | −61.899 | 1.50 | 1.72916 | 54.7 |
| 19 | 73.075 | 1.94 | | |
| 20 | −60.615 | 1.50 | 1.55200 | 70.7 |
| 21 | 1269.310 | 2.03 | | |
| 22 | 52.078 | 3.26 | 1.48749 | 70.2 |
| 23 | 336.184 | 64.76 | | |
| 24 | 177.383 | 8.95 | 1.66680 | 33.0 |
| 25 | −32.902 | 1.50 | 1.92286 | 20.9 |
| 26 | −197.247 | 0.20 | | |
| 27 | 81.419 | 10.41 | 1.65412 | 39.7 |
| 28 | −37.449 | 1.80 | 1.59282 | 68.6 |
| 29 | 102.430 | (Variable) | | |
| Image Plane | ∞ | | | |

ASPHERIC DATA
9th Surface
K = 0.00000e+00 A 4 = −2.39739e−06 A 6 = 1.88178e−09
A 8 = 3.82317e−12
10th Surface
K = 0.00000e+00 A 4 = −2.61242e−06 A 6 = 2.50565e−09
A 8 = 3.02575e−12
VARIOUS DATA

| | |
|---|---|
| Focal Length | 583.80 |
| Fno | 5.65 |
| Half Angle of View (°) | 2.12 |
| Image Height | 21.64 |
| Overall Lens Length | 366.23 |
| BF | 67.52 |
| d11 | 2.00 |
| d13 | 19.08 |
| d29 | 67.52 |

LENS UNIT DATA

| Lens Unit | Starting Surface | Focal Length |
|---|---|---|
| 1 | 1 | 187.70 |
| 2 | 12 | −134.93 |
| 3 | 14 | −595.54 |

### NUMERICAL EXAMPLE 5

UNIT: mm
SURFACE DATA

| Surface No. | r | d | nd | νd |
|---|---|---|---|---|
| 1 | 203.414 | 5.08 | 1.48749 | 70.2 |
| 2 | 405.216 | 1.00 | | |
| 3 | 132.587 | 12.21 | 1.43387 | 95.1 |
| 4 | 8940.857 | 72.63 | | |
| 5 | 86.012 | 8.93 | 1.43875 | 94.7 |
| 6 | −1957.221 | 0.87 | | |
| 7 | −468.482 | 2.50 | 1.61340 | 44.3 |
| 8 | 43.356 | 0.05 | | |
| 9 | 43.329 | 9.58 | 1.49700 | 81.5 |
| 10 | 139.785 | 55.47 | | |
| 11* | 275.586 | 4.78 | 1.49700 | 81.5 |
| 12* | −159.475 | 3.88 | | |
| 13 (SP) | ∞ | (Variable) | | |
| 14 | 370.153 | 1.30 | 1.48749 | 70.2 |
| 15 | 55.031 | (Variable) | | |
| 16 | −143.016 | 4.13 | 1.76182 | 26.5 |
| 17 | −33.026 | 1.50 | 1.91082 | 35.2 |
| 18 | −83.255 | 2.00 | | |
| 19 | 260.012 | 2.72 | 1.80810 | 22.8 |
| 20 | −84.289 | 1.50 | 1.72916 | 54.7 |
| 21 | 59.132 | 2.00 | | |
| 22 | −61.057 | 1.50 | 1.55200 | 70.7 |
| 23 | 330.747 | 2.08 | | |
| 24 | 53.630 | 2.83 | 1.48749 | 70.2 |
| 25 | 3212.424 | 58.10 | | |
| 26 | 313.855 | 8.29 | 1.72825 | 28.5 |
| 27 | −29.387 | 1.50 | 1.92286 | 20.9 |
| 28 | −930.109 | 4.29 | | |
| 29 | 135.569 | 10.43 | 1.65412 | 39.7 |
| 30 | −31.386 | 1.80 | 1.59282 | 68.6 |
| 31 | −839.737 | (Variable) | | |
| Image Plane | ∞ | | | |

ASPHERIC DATA
11th Surface
K = 0.00000e+00 A 4 = −2.29610e−06 A 6 = −5.34837e−10
A 8 = 9.93691e−14
12th Surface
K = 0.00000e+00 A 4 = −2.27700e−06 A 6 = −2.15977e−10
A 8 = 1.36594e−13
VARIOUS DATA

| | |
|---|---|
| Focal Length | 584.53 |
| Fno | 5.65 |
| Half Angle of View (°) | 2.12 |
| Image Height | 21.64 |
| Overall Lens Length | 365.61 |
| BF | 60.55 |
| d13 | 2.00 |
| d15 | 20.10 |
| d31 | 60.55 |

LENS UNIT DATA

| Lens Unit | Starting Surface | Focal Length |
|---|---|---|
| 1 | 1 | 192.73 |
| 2 | 14 | −132.78 |
| 3 | 16 | −883.66 |

### NUMERICAL EXAMPLE 6

UNIT: mm
SURFACE DATA

| Surface No. | r | d | nd | νd |
|---|---|---|---|---|
| 1 | 134.242 | 9.20 | 1.61800 | 63.4 |
| 2 | 1314.075 | 74.00 | | |
| 3 | 89.773 | 9.82 | 1.43875 | 94.7 |
| 4 | −218.240 | 2.51 | | |
| 5 | −181.652 | 2.50 | 1.65412 | 39.7 |
| 6 | 44.867 | 0.05 | | |
| 7 | 44.707 | 8.80 | 1.49700 | 81.5 |
| 8 | 207.287 | 57.67 | | |
| 9* | 347.816 | 3.48 | 1.55032 | 75.5 |
| 10* | −123.287 | 3.62 | | |
| 11 (SP) | ∞ | (Variable) | | |
| 12 | 242.034 | 1.30 | 1.51633 | 64.1 |
| 13 | 58.445 | (Variable) | | |
| 14 | −599.803 | 4.40 | 1.85478 | 24.8 |
| 15 | −32.731 | 1.50 | 1.95375 | 32.3 |
| 16 | −199.504 | 2.00 | | |
| 17 | 177.666 | 3.09 | 1.80810 | 22.8 |
| 18 | −82.435 | 1.50 | 1.74100 | 52.6 |
| 19 | 61.999 | 2.97 | | |
| 20 | −66.219 | 1.50 | 1.55200 | 70.7 |
| 21 | 298.123 | 2.08 | | |
| 22 | 47.661 | 3.19 | 1.48749 | 70.2 |
| 23 | 1188.446 | 61.13 | | |
| 24 | 169.445 | 7.23 | 1.68893 | 31.1 |
| 25 | −28.142 | 1.50 | 1.92286 | 20.9 |
| 26 | −782.884 | 0.35 | | |
| 27 | 63.393 | 8.63 | 1.65412 | 39.7 |
| 28 | −32.047 | 1.80 | 1.59282 | 68.6 |
| 29 | 63.322 | (Variable) | | |
| Image Plane | ∞ | | | |

ASPHERIC DATA
9th Surface
K = 0.00000e+00 A 4 = −1.48098e−06 A 6 = −8.95562e−10
A 8 = 2.84884e−13
10th Surface
K = 0.00000e+00 A 4 = −1.39622e−06 A 6 = −8.34937e−10
A 8 = 4.87796e−13
VARIOUS DATA

| | |
|---|---|
| Focal Length | 584.06 |
| Fno | 6.40 |
| Half Angle of View (°) | 2.12 |
| Image Height | 21.64 |
| Overall Lens Length | 366.13 |
| BF | 69.91 |
| d11 | 2.00 |
| d13 | 18.41 |
| d29 | 69.91 |

LENS UNIT DATA

| Lens Unit | Starting Surface | Focal Length |
|---|---|---|
| 1 | 1 | 185.68 |
| 2 | 12 | −149.59 |
| 3 | 14 | −165.54 |

### NUMERICAL EXAMPLE 7

UNIT: mm
SURFACE DATA

| Surface No. | r | d | nd | νd |
|---|---|---|---|---|
| 1 | 226.622 | 8.41 | 1.59349 | 67.0 |
| 2 | 831.115 | 240.34 | | |
| 3 | 87.828 | 11.24 | 1.43875 | 94.7 |
| 4 | −712.862 | 0.94 | | |
| 5 | −312.895 | 2.50 | 1.61340 | 44.3 |
| 6 | 62.670 | 0.05 | | |
| 7 | 61.068 | 9.03 | 1.43875 | 94.7 |
| 8 | 281.341 | 76.82 | | |
| 9* | 172.010 | 4.14 | 1.43875 | 94.7 |
| 10* | −164.740 | 3.73 | | |
| 11 (SP) | ∞ | (Variable) | | |
| 12 | 181.320 | 1.30 | 1.69895 | 30.1 |
| 13 | 64.810 | (Variable) | | |
| 14 | 162.527 | 5.14 | 1.69895 | 30.1 |
| 15 | −43.999 | 1.50 | 1.91082 | 35.2 |
| 16 | −184.598 | 2.00 | | |
| 17 | 595.345 | 2.87 | 1.80810 | 22.8 |
| 18 | −97.125 | 1.50 | 1.72916 | 54.7 |
| 19 | 62.351 | 2.80 | | |
| 20 | −69.032 | 1.50 | 1.55200 | 70.7 |
| 21 | 446.782 | 2.07 | | |
| 22 | 60.561 | 4.72 | 1.48749 | 70.2 |
| 23 | −131.715 | 90.50 | | |
| 24 | 68.400 | 11.19 | 1.85478 | 24.8 |
| 25 | −33.210 | 1.50 | 1.92286 | 20.9 |
| 26 | 74.621 | 8.74 | | |
| 27 | −37.445 | 1.80 | 1.49700 | 81.5 |
| 28 | 55.303 | 9.08 | 1.65412 | 39.7 |
| 29 | −57.050 | (Variable) | | |
| Image Plane | ∞ | | | |

ASPHERIC DATA
9th Surface
K = 0.00000e+00 A 4 = −1.06341e−06 A 6 = 2.00501e−10
A 8 = 4.39704e−13
10th Surface
K = 0.00000e+00 A 4 = −9.60571e−07 A 6 = 4.27979e−10
A 8 = 2.91278e−13
VARIOUS DATA

| | |
|---|---|
| Focal Length | 789.38 |
| Fno | 6.40 |
| Half Angle of View (°) | 1.57 |
| Image Height | 21.64 |
| Overall Lens Length | 600.18 |
| BF | 62.06 |
| d11 | 2.00 |
| d13 | 30.68 |
| d29 | 62.06 |

LENS UNIT DATA

| Lens Unit | Starting Surface | Focal Length |
|---|---|---|
| 1 | 1 | 282.01 |
| 2 | 12 | −144.97 |
| 3 | 14 | −2505.05 |

TABLE 1

| | Numerical Example | | | |
|---|---|---|---|---|
| | 1 | 2 | 3 | 4 |
| f | 388.73 | 389.12 | 479.13 | 583.80 |
| f1 | 145.31 | 155.61 | 160.43 | 187.70 |
| f1A | 245.65 | 252.25 | 238.17 | 231.82 |
| f1B | −636.34 | −1604.28 | −526.30 | −664.61 |
| f2 | −92.32 | −78.85 | −125.97 | −134.93 |
| LD | 310.74 | 310.56 | 331.00 | 366.23 |
| D1AB | 80.97 | 101.59 | 66.58 | 69.59 |
| D1BC | 39.50 | 17.46 | 50.00 | 49.36 |
| D1Air | 120.47 | 119.06 | 116.59 | 118.95 |
| D1 | 163.80 | 168.67 | 155.48 | 163.27 |
| Fno | 4.08 | 4.08 | 5.65 | 5.65 |
| GpR1 | 138.41 | 121.22 | 132.67 | 119.23 |
| GpR2 | 2654.66 | 617.69 | 2107.44 | 859.31 |
| sk | 55.06 | 60.09 | 55.35 | 67.52 |
| (1)f1A/f1 | 1.69 | 1.62 | 1.48 | 1.24 |
| (2)f1A/f1B | −0.39 | −0.16 | −0.45 | −0.35 |
| (3)f1A/f | 0.632 | 0.648 | 0.497 | 0.397 |
| (4)D1AB/D1BC | 2.05 | 5.82 | 1.33 | 1.41 |
| (5)f2/f1 | −0.64 | −0.51 | −0.79 | −0.72 |
| (6)LD/f | 0.799 | 0.798 | 0.691 | 0.627 |
| (7)f1/f | 0.37 | 0.40 | 0.33 | 0.32 |
| (8)D1Air/D1 | 0.74 | 0.71 | 0.75 | 0.73 |
| (9)Nd1CP | 1.50 | 1.44 | 1.44 | 1.50 |
| (10)νd1CP | 81.54 | 94.66 | 94.66 | 81.54 |
| (11)DRMAX | 0.027 | 0.037 | 0.039 | 0.023 |
| (12)SF1AP | −1.11 | −1.49 | −1.13 | −1.32 |
| (13)sk/LD | 0.18 | 0.19 | 0.17 | 0.18 |

| | Numerical Example | | |
|---|---|---|---|
| | 5 | 6 | 7 |
| f | 584.53 | 584.06 | 789.38 |
| f1 | 192.73 | 185.68 | 282.01 |
| f1A | 227.34 | 241.22 | 522.29 |
| f1B | −533.74 | −472.71 | −4401.32 |
| f2 | −132.78 | −149.59 | −144.97 |
| LD | 365.61 | 366.13 | 600.18 |
| D1AB | 72.63 | 74.00 | 240.34 |
| D1BC | 55.47 | 57.67 | 76.82 |
| D1Air | 128.10 | 131.66 | 317.17 |
| D1 | 173.11 | 168.02 | 353.49 |
| Fno | 5.65 | 6.40 | 6.40 |
| GpR1 | 132.59 | 134.24 | 226.62 |
| GpR2 | 8940.86 | 1314.08 | 831.11 |
| sk | 60.55 | 69.91 | 62.06 |
| (1)f1A/f1 | 1.18 | 1.30 | 1.85 |
| (2)f1A/f1B | −0.43 | −0.51 | −0.12 |
| (3)f1A/f | 0.389 | 0.413 | 0.662 |
| (4)D1AB/D1BC | 1.31 | 1.28 | 3.13 |
| (5)f2/f1 | −0.69 | −0.81 | −0.51 |
| (6)LD/f | 0.625 | 0.627 | 0.760 |
| (7)f1/f | 0.33 | 0.32 | 0.36 |
| (8)D1Air/D1 | 0.74 | 0.78 | 0.90 |
| (9)Nd1CP | 1.50 | 1.55 | 1.44 |
| (10)νd1CP | 81.54 | 75.50 | 94.66 |
| (11)DRMAX | 0.059 | 0.044 | 0.031 |
| (12)SF1AP | −1.03 | −1.23 | −1.75 |
| (13)sk/LD | 0.17 | 0.19 | 0.10 |

### Image Pickup Apparatus

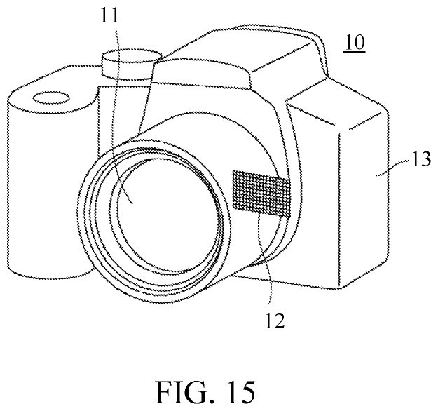

FIG. 15 illustrates a digital still camera 10 as an image pickup apparatus using the optical system according to any one of the above examples as an imaging optical system. Reference numeral 13 denotes a camera body, and reference numeral 11 denotes an imaging optical system including any one of the optical systems according to Examples 1 to 7. A solid-state image sensor 12, such as a CCD sensor or a CMOS sensor, is built in the camera body 13 and captures an optical image (object image) formed by the imaging optical system 11.

Using the optical system according to each example can provide a camera that is small and bright, and can acquire high-quality images.

The camera may be a single-lens reflex camera with a quick turn mirror, or a mirrorless camera without a quick turn mirror. As described above, the zoom lenses according to Examples 1 to 7 can be used for various image pickup apparatuses such as video cameras, broadcasting cameras, and surveillance cameras.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

Each example can provide a small and lightweight optical system that can satisfactorily correct various aberrations while having a sufficient aperture ratio.

This application claims priority to Japanese Patent Application No. 2023-079491, which was filed on May 12, 2023, and which is hereby incorporated by reference herein in its entirety.

What is claimed is:

1. An optical system comprising, in order from an object side to an image side:
a first lens unit having positive refractive power;
a second lens unit having negative refractive power; and
a rear lens unit,
wherein the first lens unit includes, in order from the object side to the image side, a first partial lens unit, a second partial lens unit, and a third partial lens unit, a first air gap being formed between the first partial lens unit and the second partial lens unit, and a second air gap being formed between the second partial lens unit and the third partial lens unit,
wherein the first air gap is maximum among air gaps on an optical axis in the first lens unit, and the second air gap is second maximum among the air gaps on the optical axis in the first lens unit,
wherein the second lens unit moves during focusing, and
wherein the following inequalities are satisfied:
$$\begin{matrix}1. \leq f 1 A / f 1 \leq 2. \\ - 0.6 \leq f 1 A / f 1 B < 0 \\ 0.5 \leq LD / f \leq 1.\end{matrix}$$
where f1 is a focal length of the first lens unit, f1A is a focal length of the first partial lens unit, f1B is a focal length of the second partial lens unit, LD is a distance on the optical axis from a lens surface closest to an object in the optical system to an image plane, and f is a focal length of the optical system.

2. The optical system according to claim 1, wherein the following inequality is satisfied:
$$0.3 \leq f 1 A / f \leq 0.75 .$$

3. The optical system accords to claim 1, wherein the following inequality is satisfied:
$$1.3 \leq D 1 AB / D 1 BC \leq 7.$$
where D1AB is an air gap between the first partial lens unit and the second partial lens unit, and D1BC is an air gap between the second partial lens unit and the third partial lens unit.

4. The optical system according to claim 1, wherein the following inequality is satisfied:
$$- 0.95 \leq f 2 / f 1 \leq - 0.4$$
where f2 is a focal length of the second lens unit.

5. The optical system according to claim 1, wherein the following inequality is satisfied:
$$0.2 \leq f 1 / f \leq 0.5 .$$

6. The optical system accords to claim 1, wherein the following inequality is satisfied:
$$0.6 \leq D 1 Air / D 1 \leq 1.$$
where D1AB is the air gap between the first partial lens unit and the second partial lens unit, D1BC is the air gap between the second partial lens unit and the third partial lens unit, D1Air is a sum of D1AB and D1BC, and D1 is a thickness of the first lens unit on the optical axis.

7. The optical system according to claim 1, wherein the following inequality is satisfied:
$$1.3 \leq nd 1 CP \leq 1.65$$
where nd1CP is a refractive index for d-line of a positive lens disposed closest to the object in the third partial lens unit.

8. The optical system according to claim 1, wherein the following inequality is satisfied:
$$65. \leq vd 1 CP \leq 90.$$
where vd1CP is an Abbe number based on d-line of a positive lens disposed closest to the object in the third partial lens unit.

9. The optical system according to claim 1, wherein the third partial lens unit includes a lens having an aspherical surface, and
wherein the following inequality is satisfied:
$$0. \leq DR MAX \leq 0.08$$
where DRMAX is an absolute value of a maximum value of an aspherical amount of the aspherical surface.

10. The optical system according to claim 1, wherein the following inequality is satisfied:
$$- 2. \leq ( R 2 + R 1 ) / ( R 2 - R 1 ) \leq - 0.08$$
where R1 is a radius of curvature of a lens surface on the object side of a lens having a strongest positive refractive power among one or more lenses included in the first lens unit, and R2 is a radius of curvature of a lens surface on the image side of the lens having the strongest positive refractive power among the one or more lenses included in the first lens unit.

11. The optical system according to claim 1, wherein the following inequality is satisfied:
$$0.05 \leq sk / LD \leq 0.24$$
where sk is a back focus of the optical system in an in-focus state at infinity, and LD is an overall optical length of the optical system.

12. The optical system according to claim 1, wherein the first partial lens unit has positive refractive power, the second partial lens unit has negative refractive power, and the third partial lens unit has positive refractive power.

13. The optical system according to claim 1, wherein the second partial lens unit consists of one negative lens and two positive lenses.

14. The optical system according to claim 1, wherein the third partial lens unit has an aspheric lens closest to the image plane.

15. The optical system according to claim 1, wherein the second lens unit consists of a single negative lens.

16. The optical system according to claim 1, wherein a lens surface closest to the image plane in the rear lens unit is convex toward the image side.

17. The optical system according to claim 1, wherein the second lens unit includes an aperture stop closest to the object.

18. The optical system according to claim 17, wherein a lens adjacent to the aperture stop on the image side is a cemented lens of a positive lens and a negative lens.

19. The optical system according to claim 1, wherein the rear lens unit has positive or negative refractive power.

20. An image pickup apparatus comprising:
an optical system; and
an image sensor configured to capture an object through the optical system,
wherein the optical system includes, in order from an object side to an image side:
a first lens unit having positive refractive power;
a second lens unit having negative refractive power; and
a rear lens unit,
wherein the first lens unit includes, in order from the object side to the image side, a first partial lens unit, a second partial lens unit, and a third partial lens unit, a first air gap being formed between the first partial lens unit and the second partial lens unit, and a second air gap being formed between the second partial lens unit and the third partial lens unit,
wherein the first air gap is maximum among air gaps on an optical axis in the first lens unit, and the second air gap is second maximum among the air gaps on the optical axis in the first lens unit,
wherein the second lens unit moves during focusing, and
wherein the following inequalities are satisfied:
$$\begin{matrix}1. \leq f 1 A / f 1 \leq 2. \\ - 0.6 \leq f 1 A / f 1 B < 0 \\ 0.5 \leq LD / f \leq 1.\end{matrix}$$
where f1 is a focal length of the first lens unit, f1A is a focal length of the first partial lens unit, f1B is a focal length of the second partial lens unit, LD is a distance on the optical axis from a lens surface closest to an object in the optical system to an image plane, and f is a focal length of the optical system.
